(19) United States
(12) Patent Application Publication
(10) Pub. No.: US 2008/0224338 A1
(43) Pub. Date: Sep. 18, 2008

(54) METHOD FOR PRODUCING A PHOTOCHROMIC PLASTIC ARTICLE

(75) Inventors: Herbert Zinner, Rohrbach (DE); Herbert Schuster, Emmering (DE)

Correspondence Address: CROWELL & MORING LLP;INTELLECTUAL PROPERTY GROUP, P.O. BOX 14300, WASHINGTON, DC, 20044-4300, US

(73) Assignee: RODENSTOCK GMBH, MUENCHEN (DE)

(21) Appl. No.: 11/941,916

(22) Filed: Nov. 16, 2007

Related U.S. Application Data
(63) Continuation of application No. PCT/EP2006/004693, filed on May 17, 2006.

(30) Foreign Application Priority Data
May 18, 2005 (DE) DE 102005022860.7

(51) Int. Cl. B29D 11/00

(52) U.S. Cl. 264/1.7

(57) ABSTRACT

A method for producing a photochromic synthetic resin object, comprising:

(a) applying a layer, comprising at least one liquid monomer suitable for forming a polymer and at least one photochromic dyestuff, to at least one internal surface area of a first casting mold situated in a casting assembly, and partially or completely curing the layer to form a photochromic polymer layer;
(b) optionally applying a protective layer to the completely or partially cured photochromic polymer layer, and curing the protective layer;
(c) introducing a casting resin into the casting assembly which comprises a predetermined mold cavity formed by the first casting mold together with a second casting mold in the casting assembly, and
(d) curing the casting resin to form a photochromic synthetic resin object;
and a photochromic synthetic resin object produced by this method.

### CROSS REFERENCE TO RELATED APPLICATIONS

This application is a continuation of international patent application no. PCT/EP2006/004693, filed May 17, 2007, designating the United States of America, and published in German on Nov. 23, 2006 as WO 2006/122795, the entire disclosure of which is incorporated herein by reference. Priority is claimed based on Federal Republic of Germany patent application no. DE 10 2005 022 860.7, filed May 18, 2005.

### BACKGROUND OF THE INVENTION

The present invention relates to a method for producing a photochromic synthetic resin object and a photochromic synthetic resin object obtained thereby having a photochromic layer in optical quality, this method being suitable both for polymer systems having a low and moderate index of refraction and also for polymer systems having a high index of refraction.

Up to this point, the following methods (1) through (3) have been used for producing photochromic synthetic resin objects:

### (1) Mass Coloring:

The photochromic compounds are introduced into a monomer and this mixture is cured by thermal or photochemical polymerization (compare DE 43 25 154 C1 and US 2003/0158284 A1). This method is not suitable for producing systems made of polymers having a low or moderate index of refraction, however.

### (2) Surface Coloring:

A lacquer layer, which contains photochromic compounds in high concentration, is applied to an object. Upon heating of the object, there is a thermal transfer of the photochromic compounds from the lacquer layer into the polymer matrix of the object. The lacquer is subsequently removed again. This method is also restricted to systems having a low or moderate index of refraction and requires a special adaptation of the polymer matrix to the diffusion behavior of the photochromic compounds.

### (3) Lacquer Photochromism:

A lacquer layer, which contains the photochromic compounds, is applied to an object. This method is also suitable for polymer systems having a high index of refraction, but it is complex and not cost-effective.

### SUMMARY OF THE INVENTION

It is an object of the present invention to provide an improved method for producing an optical quality photochromic layer.

Another object of the invention is to provide a simple and cost-effective method for producing a photochromic synthetic resin (i.e., plastic) object having an optical quality photochromic layer which is suitable for mass production.

A further object of the invention is to provide a method for producing an optical quality photochromic layer which is suitable not only for polymer systems having a low or moderate index of refraction, but also for polymer systems having a high index of refraction.

These and other objects are achieved by the present invention as described and claimed hereinafter.

In particular, according to the present invention, a method for producing a photochromic synthetic resin object is provided, comprising the following steps:
(a) applying a layer comprising at least one liquid monomer suitable for forming a polymer and at least one photochromic dyestuff onto at least one internal surface area of a first casting mold situated in a casting assembly, and partially or completely curing the layer to form a photochromic polymer layer;
(b) optionally applying a protective layer to the completely or partially cured photochromic polymer layer, and curing the protective layer;
(c) pouring a casting resin into said casting assembly, which comprises a predetermined mold cavity formed by said first casting mold together with a second casting mold, and
(d) curing the casting resin to form a photochromic synthetic resin object.

Thus, in accordance with the present invention, the photochromic layer is already introduced during or in the course of producing such photochromic synthetic resin objects, e.g. synthetic resin eyeglass lenses, in particular. After removal of the casting mold, the photochromic layer adheres to the cured casting resin. Using the method according to the present invention, photochromic layers having a layer thickness of over 30 μm in particular may also be provided in optical quality in a simple way, independently of the refractive index of the selected lens or synthetic resin material.

In step (a) to form the photochromic polymer layer, i.e., the layer containing at least one photochromic dyestuff, a liquid mixture comprising one or more photochromic compound(s), one or more curable monomers or a suitable mixture made of two or more components or monomers which are curable with one another, and, if necessary, one or more photoinitiators or one or more thermal initiators, is applied to the internal surface of a casting mold as part of a casting assembly.

The curable materials or monomers suitable according to the present invention for the photochromic polymer layer are not subject to any special restriction and are known to those skilled in the art. Typically, those materials suitable for producing cured synthetic resin objects which provide transparent synthetic resin objects are used. Photochemically curable or thermally curable monomers, such as mono-, di-, or tri(meth)acrylate monomers in particular, corresponding thio(meth)acrylates or monomers which form polyurethanes, i.e., at least one diol or polyol and at least one diisocyanate or polyisocyanate, are preferably used. Mono-, di-, or tri(meth)acrylate monomers are most preferred. As used herein, the term “(meth)acrylates” should be understood to include both acrylates and also methacrylates.

Suitable photochromic substances are known to those skilled in the art and comprise, for example, chromenes, fulgides, fulgimides, spirooxazines, naphthopyrans, or mixtures thereof. Examples of suitable photochromic substances are described, for example, in U.S. Pat. Nos. 5,399,687; 5,498,686; 5,623,005; 5,645,768; 5,707,557; 5,801,243; 5,932,725; 5,952,515; 5,990,305; 6,022,496; 6,036,890; 6,102,543; 6,146,554; 6,171,525; 6,190,580; and 6,225,466; US patent publication no. 2003/0158284 A1, and German patent no. DE 43 25 154 C1.

Suitable photoinitiators for use in the present invention are known to those skilled in the art and preferably have an absorption at wavelengths greater than 400 nm. Examples of suitable photoinitiators include benzophenone, 2,2-dimethoxy-2-phenyl-acetophenone, 1-hydroxycyclohexyl phenyl ketone, 2-methyl-1-[4-(methylthio)phenyl]-2-morpholinopropane-1-one, 2-hydroxy-2-methyl-1-phenylpropane-1-one, bis(2,6-dimethoxybenzoyl)-2,4,4-trimethylpentyl phosphine oxide, 2,4,6-trimethylbenzoyldiphenyl phosphine oxide, bis(2,4,6-trimethylbenzoyl)phenyl phosphine oxide, and mixtures thereof.

Thermal initiators suitable for use in the present invention also are known to those skilled in the art and are not subject to any special restriction. Examples of suitable thermal initiators include t-amylperoxy-2-ethylhexanoate, t-butylperoxy-2-ethylhexanoate, t-butylperoxy-2-methylbenzoate, 1,1-di-(t-butylperoxy)-3,3,5-trimethylcyclohexane, t-butylperoxy-3,5,5-trimethyl hexanoate, t-butylperoxy-2-ethylhexyl carbonate, dibenzoyl peroxide, t-amylperoxybenzoate, 2,2′-azobis(2,4-dimethylpentane nitrile), 2,2′-azobis(2-methyl propane nitrile), 2,2′-azobis(2-methyl butane nitrile), 1,1′-azobis(cyclohexane carbonitrile), and mixtures thereof.

Preferably, one or more photoinitiators, as described above for illustrative purposes, are used for carrying out the formation of the photochromic polymer layer.

The thickness of the partially or completely cured photochromic polymer layer is not subject to any special restriction, but is preferably in a range from about 20 μm to about 200 μm.

The protective layer(s) is/are synthesized from typical materials known to those skilled in the art. The protective layer(s) may be synthesized from the same materials as the photochromic polymer layer without any photochromic substances being provided therein. However, photochemically curable or thermally curable monomers are preferred for the protective layer(s) and mono-, di-, or tri(meth)acrylate monomers or mixtures thereof are especially preferred. The protective layer may, if desired, also contain one or more photoinitiator(s) or one or more thermal initiators(s).

The thickness of the partially or completely cured protective layer is not subject to any special restriction, but is preferably in a range from about 0.1 μm to about 10 μm.

The protective layer(s) described in the present application is/are particularly provided if there is an incompatibility between a component of the photochromic polymer layer and the casting resin. An incompatibility of this type exists, for example, between a photochromic substance present in the photochromic layer and a sulfurous monomer of the casting resin. Fundamentally, however, it is also conceivable not to provide a protective layer even if a sulfurous material is used as the casting resin, if the photochromic layer has been sufficiently cured before introduction of a sulfurous casting resin into the casting assembly.

Casting resins suitable for use in the present invention are not subject to any special restriction. Typical materials suitable for producing synthetic resin objects, in particular synthetic resin eyeglass lenses, may be used. The casting resin materials suitably used in the present invention for forming the photochromic synthetic resin object typically display, after mass curing, a water absorption of at most 1% (measured during 8 hours storage time at 40° C.), a ball impression hardness of at least 90 N/mm² (measured according to ISO 2039-1), a modulus of elasticity of at least 2000 N/mm² (measured according to EN ISO 178), and a mechanical strength of greater than 6 kJ/m² (measured by the impact bending test according to Charpy according to ISO 179/1 flU).

It is, however, preferred within the scope of the present invention to use a photochemically curable or thermally curable monomer, such as a mono-, di-, or tri(meth)acrylate monomer, polyalkylene glycol bis-allyl carbonates, such as diethylene glycol bis-allyl carbonate, a mixture of at least one dithiol or polythiol and at least one diisocyanate or polyisocyanate to form a polythiourethane [cf. U.S. Pat. No. 5,679,756 (=EP 780,413)], such as MR6, MR7, MR8, and MR20 (distributed by Mitsui Chemical Corporation), a mixture made of at least one diol or polyol and at least one diisocyanate or polyisocyanate to form a polyurethane, or a mixture made of a bis-episulfide and a compound having at least one active hydrogen atom to form a polyepisulfide [cf. U.S. Pat. No. 6,225,439 (=EP 921,417)], such as IU-20 (distributed by Mitsubishi Gas Chemicals). One or more photoinitiator(s) or one or more thermal initiator(s) or additives, such as light stabilization agents, release agents, and/or processing aids, may also be added to the casting resin in a suitable quantity.

The photochromic polymer layer, which is applied to at least one internal surface area, typically to the entire surface, of a casting mold (i.e., the side of the casting mold facing toward the photochromic synthetic resin object be produced), may cover a significant area of the resulting photochromic synthetic resin object, the entire surface of the photochromic synthetic resin object, or, for example, one side or two sides of the photochromic synthetic resin object to be produced, in particular one side of a photochromic eyeglass lens. A photochromic eyeglass lens preferably has the photochromic layer on the side of the lens facing away from the eyeglass wearer.

The photochromic polymer layer applied to at least one area of the internal surface of the casting mold is partially (for example, up to the gel point) or completely cured. Photochemical curing, e.g., by UV radiation, or thermal curing is preferred. It may be advantageous to cure the photochromic polymer layer or its material only partially, for example, up to the gel point, if improved adhesion between the photochromic polymer layer and the adjoining layer may thus be achieved.

Step (d), the curing of the casting resin, may optionally also comprise complete curing of the previously applied photochromic polymer layer, if it was only partially, i.e., incompletely cured in step (a).

As used herein the term “casting assembly” should be understood to refer to a configuration which comprises one or more, typically two, casting molds or mold shells (i.e., specific parts of the casting assembly which define a predetermined spatial shape) and a sealing ring holding these casting molds together, so that a predetermined cavity is formed. The sealing ring holds the two molding shells or casting molds together and produces the precise intermediate space which receives liquid monomer. The casting assembly is constructed in such a way that it may receive the liquid casting resin material, which subsequently represents the bulk material for the photochromic synthetic resin object to be produced, and forms the photochromic synthetic resin object after curing of the casting resin. The cavity which is defined in the casting assembly is not subject to any significant restriction. However, it is preferred to produce the cavity of the casting assembly in the form of a lens, preferably an eyeglass lens. It is also, however, possible to form other geometric shapes which may be suitable for photochromic applications.

In the course of producing photochromic synthetic resin objects, such as photochromic lenses in particular, a softer photochromic polymer layer may also be provided to allow more rapid response behavior and/or a more rapid color change of the photochromic substance(s). If currently available photochromic compounds and base materials suitable for eyeglass lenses are used, fade or lightening speeds which are suitable for rapid light intensity changes are not achievable. For this purpose, variables determined by measurement techniques, such as Δτ₂ₘᵢₙ (i.e., transmission after 2 minutes of lightening−transmission after 15 minutes of exposure), Δτ₁₀ₘᵢₙ (i.e., transmission after 10 minutes of lightening−transmission after 15 minutes of exposure), or t_{1/2}, i.e., the half-life of the photochromic shift in the lightening phase, are suitable as the measured variable. The suitability of synthetic resin or casting resin materials for use in optical lenses is limited by measured variables such as a water absorption of at most 1% (measured during 8 hours storage time at 40° C.), a ball impression hardness of at least 90 N/mm², a modulus of elasticity of at least 2000 N/mm², and a mechanical strength of greater than 6 kJ/m². Synthetic resin materials which would ensure extremely rapid lightening behavior, however, do not meet the above usage properties. Therefore, in the course of providing so-called “rapid” photochromic layers up to the present time, laminate systems have been developed in which a photochromic matrix incompatible with synthetic resin materials is embedded in two polycarbonate plates and thus isolated from the synthetic resin material. A disadvantage of such a procedure is exceedingly difficult and complex procedure required to introduce the laminate into the nonplanar molds needed for producing such synthetic resin lenses. It is currently thus also necessary to introduce “rapid” photochromism layers into a synthetic resin mass in a separate layer.

Against this background, it may therefore be preferable in the method of the present invention for producing a photochromic synthetic resin object, particularly if soft synthetic resin materials are envisioned for the photochromic matrix or layer, before the step of applying a photochromic polymer layer to the internal surface of the casting mold (i.e., before step (a) as described above), to apply a layer made of a first casting resin to at least one area of the internal surface of the first casting mold, which is completely or partially cured, a further protective layer being able to be provided if necessary between this first casting resin layer and the photochromic layer.

Therefore, according to the present invention, a method for producing a photochromic synthetic resin object is also provided, comprising the following steps:
applying a layer made of a first casting resin to at least one area of the internal surface of a first casting mold situated in a casting assembly, completely or partially curing the first casting resin, and optionally providing and curing a protective layer on the completely or partially cured first casting resin layer;
applying a layer comprising at least one liquid monomer suitable for forming a polymer and at least one photochromic dyestuff to the completely or partially cured first casting resin layer or the protective layer, and partially or completely curing the layer to form a photochromic polymer layer;
optionally applying a further protective layer to the completely or partially cured photochromic polymer layer, and curing the protective layer;
introducing a second casting resin into the casting assembly, which comprises a predetermined mold cavity formed by said first casting mold together with a second casting mold, and
curing the second casting resin to form a photochromic synthetic resin object.

Therefore, according to this method, the step of initially embedding the “rapid” photochromic layer in a laminate and polymerizing this into the synthetic resin mass is omitted in that the corresponding layers are produced during the process of producing the photochromic synthetic resin object or the process of producing the synthetic resin lens.

According to this embodiment, i.e., if a soft synthetic resin material is provided for the photochromic matrix or polymer layer, its material is selected in such a way that its ball impression hardness is typically less than 80 N/mm², preferably 20-60 N/mm², measured after complete curing. This means that the ball impression hardness of such a “soft” polymer layer, taken per se after appropriate curing, is typically less than 80 N/mm². The modulus of elasticity of such a completely cured photochromic layer is typically less than 1500 N/mm², preferably 500-1200 N/mm². Again, mono-, di-, or tri(meth)acrylate monomers particularly come into consideration for a “soft” photochromic polymer layer of this type. Adjusting the existing parameters is within the typical practice of one skilled in the art and may be achieved by varying the chain length of the resulting polymers, using appropriate functional groups in the spacer units, or adding additives such as softeners or plasticizers, in particular, etc.

The layer made of a first casting resin is again not subject to any significant restriction. Suitable materials for the first casting resin layer are the materials described above for the casting resin. The casting resin forming the first casting resin layer is preferably synthesized from the same material as the second casting resin. However, it is also possible to use different materials for the second casting resin and the first casting resin layer. The thickness of the first casting resin layer is not subject to any special restriction, but is preferably in the range from about 20 μm to about 500 μm.

The curing of the first casting resin layer and/or the protective layer(s) is carried out by typical methods known in this field. Photochemical curing, for example, by UV radiation, and/or thermal curing are preferred. The first casting resin and/or the protective layer are preferably partially or completely cured immediately after application.

### BRIEF DESCRIPTION OF THE DRAWINGS

The invention will be described in further detail hereinafter with reference to illustrative preferred embodiments shown in the accompanying drawing figures, in which:

FIG. 1 is a schematic representation of a casting assembly having a cavity delimited by the two casting molds, comprising a first (convex) casting mold (GF1) and a second (concave) casting mold (GF2), with a photochromic layer (3) applied to the internal surface of the first casting mold (GF1), and a casting resin (1) introduced into the casting assembly. Furthermore, an optional protective layer (2) is shown, which may be applied on the side of the photochromic layer (3) facing toward the casting resin (1).

FIG. 2 is a schematic representation of a casting assembly, comprising a first (convex) casting mold (GF1) and a second (concave) casting mold (GF2), with a first casting resin layer (5) applied to the internal surface of the first casting mold (GF1) and a photochromic polymer layer (3) applied to the first casting resin layer (5). The casting assembly is filled with a second casting resin (6). Furthermore, optional protective layers (2) and (4), which enclose and/or protect the photochromic polymer layer (3), are shown.

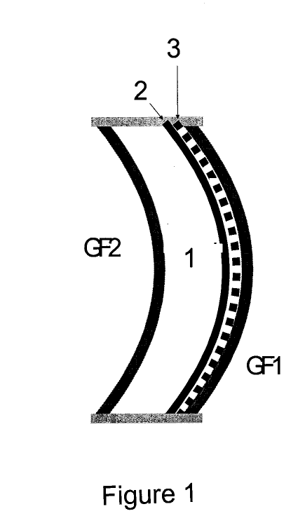

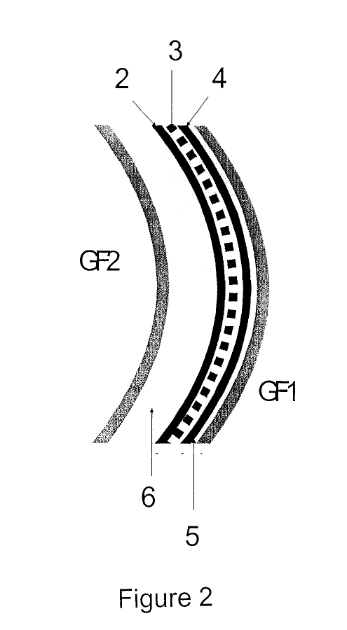

The internal shape of the casting assembly is not subject to any special restriction. The casting assembly may be constructed in one, two, three, or more parts. The internal shape of the casting assembly is a function of the desired shape of the photochromic synthetic resin object to be produced. The casting assembly is preferably constructed in such a way that the cavity provided therein forms the shape of an eyeglass lens (cf. FIGS. 1 and 2). This may typically be achieved, for example by arranging convex and/or concave casting molds or molding shells in the casting assembly using an appropriate sealing ring. According to an especially preferred embodiment, the casting assembly for an eyeglass lens comprises two casting molds, the first casting mold (GF1) having a convex shape and the second casting mold having a concave shape (GF2) (cf. FIGS. 1 and 2).

The photochromic layer, the protective layer(s), and/or the first casting resin layer are applied by typical methods known to those skilled in the art, for example, by spin coating, spray coating, or dip coating.

The casting resin is cured to form a photochromic synthetic resin object by typical methods known in this field. Photochemical curing, preferably by UV radiation, and/or thermal curing are preferred. The casting resin (as the bulk material of the photochromic synthetic resin object to be produced) is preferably completely cured.

The bulk material or mass of the cured photochromic synthetic resin object (i.e., the cured (second) casting resin) is preferably a polythiourethane, polyurethane, polyepisulfide, poly(meth)acrylate or polyethylene glycol bis-allyl carbonate, or a mixture of two or more of these materials. However, it is also possible to use a polycarbonate. Examples of especially preferred bulk materials or materials for the first casting resin layer include CR39, MR6, MR7, MR8, MR10, IU20 and CR407 (distributed by PPG Industries).

In addition, according to the present invention, a photochromic synthetic resin object is provided which is produced by the method of the present invention. The photochromic synthetic resin object according to the present invention is distinguished by a photochromic layer applied thereto in optical quality, in particular even at layer thicknesses above 20 μm, and is suitable for both polymer systems having a low or moderate index of refraction (e.g., acrylate or methacrylate as the bulk material), and also for systems having a high index of refraction (e.g., polythiourethanes as the bulk material).

The photochromic synthetic resin objects producible according to the present invention are not subject to any significant restriction in regard to their shape, and photochromic synthetic resin objects may be produced in greatly varying shapes. According to an especially preferred embodiment, the photochromic synthetic resin object is a photochromic synthetic resin eyeglass lens or a lens for another optical application.

In particular if a photochromic synthetic resin lens is produced for a spectacle lens, it is advantageous if the casting assembly comprises two casting molds GF1 and GF2 of convex or concave design, as shown in FIGS. 1 and 2.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for producing a photochromic synthetic resin object, said method comprising:
(a) applying a layer comprising at least one liquid monomer suitable for forming a polymer and at least one photochromic dyestuff to at least one internal surface area of a first casting mold situated in a casting assembly, and partially or completely curing the layer to form a photochromic polymer layer;
(b) optionally applying a protective layer to the completely or partially cured photochromic polymer layer, and curing the protective layer;
(c) introducing a casting resin into the casting assembly which comprises a predetermined mold cavity formed by said first casting mold together with a second casting mold, and
(d) curing the casting resin to form a photochromic synthetic resin object.

2. A method according to claim 1, said method comprising:
applying a layer made of a first casting resin to at least one area of the internal surface of a first casting mold situated in a casting assembly, completely or partially curing the first casting resin layer and possibly providing and curing a protective layer on the completely or partially cured first casting resin layer;
applying a layer comprising at least one liquid monomer suitable for forming a polymer and at least one photochromic dyestuff to the completely or partially cured first casting resin layer or the protective layer, and partially or completely curing the photochromic dyestuff-containing layer to form a photochromic polymer layer;
optionally applying a further protective layer to the completely or partially cured photochromic polymer layer, and curing the protective layer;
introducing a second casting resin into the casting assembly which comprises a predetermined mold cavity formed by said first casting mold together with a second casting mold, and
curing the second casting resin to form a photochromic synthetic resin object.

3. A method according to claim 2, wherein the fully cured photochromic polymer layer comprises a soft synthetic resin material having a ball impression hardness of less than 80 N/mm², and a modulus of elasticity of less than 1500 N/mm².

4. A method according to claim 3, wherein the fully cured photochromic polymer layer has a ball impression hardness of 20 to 60 N/mm², and a modulus of elasticity of 500 to 1200 N/mm².

5. A method according to claim 3, wherein the synthetic resin material for the photochromic polymer layer is formed from mono-, di-, or tri(meth)acrylate monomers.

6. A photochromic synthetic resin object produced by the process of claim 1.

7. A photochromic synthetic resin object produced by the process of claim 2.

8. A photochromic synthetic resin object produced by the process of claim 3.

9. A photochromic synthetic resin object produced by the process of claim 4.

10. A photochromic synthetic resin object produced by the process of claim 5.
